(19) United States
(12) Patent Application Publication
(10) Pub. No.: US 2018/0304748 A1
(43) Pub. Date: Oct. 25, 2018

(54) LOADING-RAMP SAFETY DEVICE

(71) Applicant: CATAC CAPITAL GmbH, Anif (AT)

(72) Inventor: Michael Marshall, Anif (AT)

(73) Assignee: CATAC CAPITAL GmbH, Anif (AT)

(21) Appl. No.: 15/769,782

(22) PCT Filed: Sep. 16, 2016
(86) PCT No.: PCT/EP2016/071918

§ 371 Date: Apr. 20, 2018

(30) Foreign Application Priority Data
Oct. 21, 2015 (DE) 10 2015 117 957.1

(51) Int. Cl. B60K 28/08; B65G 69/28

(52) U.S. Cl. CPC B60K 28/08; B60P 1/00; B65G 69/2882

(57) ABSTRACT

The invention relates to a loading-ramp safety device (10) for a loading ramp (14) to be laid onto a truck (12), comprising a signal device (20) associated with the loading ramp and a blocking device (22) associated with the truck. According to the invention, the signal device is designed to send a signal (24) regarding the loading situation at the loading ramp, and the blocking device is arranged on board the truck and furthermore is designed to receive the signal and to prevent the truck from moving away from the loading ramp in accordance with the signal.

### TECHNICAL FIELD

The invention relates to a loading-ramp safety device for a loading ramp to be laid onto a truck having a signaling device associated with the loading ramp and a blocking device associated with the truck. It also relates to a lift table or a combination of a lift table with a loading ramp, respectively a dock leveler.

### BACKGROUND

Loading ramps are aids for the loading and unloading of utility vehicles, particularly trucks. The loading ramps, which are also termed dock levelers, generally establish a connection between the cargo area of a truck and the loading dock of a building or the like. By means of the loading ramp a distance between the cargo area of the truck and the loading dock of the building is thus bridged because the truck cannot by itself dock directly onto the loading dock of buildings. Moreover, since the cargo areas of trucks are at different heights measured from the roadway, the different height levels of loading docks of buildings and cargo areas of trucks are also compensated for by means of loading ramps. In particular, the loading ramps further serve to drive e.g. a pallet truck or a forklift onto the cargo area of the truck, and to load or unloaded pallets and articles from the cargo area of the truck.

During this loading or unloading of the truck there is a risk of an accident caused by unintentional rolling away or a premature driving away of the truck, which can cause a pallet truck or forklift, including its operator, to fall off the loading ramp. Therefore, a rolling or premature driving away of a truck is to be prevented if at all possible. Such accidents have already resulted in serious injuries, mutilations, and even deaths.

It is generally known to use an optical signal, particularly in the form of a traffic light, to signal the driver of the truck whether he may move the truck away from the loading ramp or not.

EP 0 452 519 discloses a device for holding a vehicle onto a loading ramp that becomes effective upon docking and prevents by mechanical means such an unintentional rolling or premature driving away of the vehicle.

### SUMMARY

The invention has the underlying purpose of creating a loading-ramp safety device by means of which in a particularly advantageous way a truck is prevented from an otherwise possible movement away from the loading ramp.

According to the invention, this purpose has been accomplished with a loading-ramp safety device for a loading ramp to be laid onto a truck that has a signaling device associated with the loading ramp and a blocking device associated with the truck. The signaling device is configured to send a signal regarding the loading situation at the loading ramp. The blocking device is arranged on board the truck, configured to receive the signal, and, according to the signal, to prevent the truck itself from moving away from the loading ramp.

Conventional loading-ramp safety devices in which the movement of the truck is prevented by means of a mechanical device may cause damage to the truck as well as to the loading-ramp safety device itself. The invention helps prevent such damage, and protects workers as well as equipment such as trucks and forklifts.

If a driver of a truck is signaled only by means of an optical signal, such as a traffic light device, whether he may move the truck away from the loading ramp, it cannot be guaranteed that the driver always observes this optical signal without error. Moreover, it can happen that the traffic light device malfunctions, is obstructed, or is simply disregarded by the driver.

On the contrary, with the loading-ramp safety device according to the invention the signaling device sends a signal regarding the loading situation at the loading ramp. The signaling device detects what loading situation prevails on the loading ramp. If the loading ramp is not connected to the truck, the loading situation is such that a loading or unloading of the truck is not possible. If the loading ramp is connected to the truck, the loading situation is such that the truck could be loaded or unloaded.

In this latter-described loading situation, the signaling device according to the invention preferably transmits an appropriate signal to the blocking device. Preferably, the signal for that purpose will be transmitted wirelessly to the blocking device. The signal transmission can also be carried out over a cable connection. The transmission of the signal may be based on radio waves, Bluetooth, WLAN or BUS systems. The blocking device is arranged on board the truck, i.e., particularly that it is on or in the truck and there directly affects it. The blocking device on the truck prevents the truck itself from moving away from the loading ramp. The blocking device is thus located on the truck itself and moves together with it. If the truck leaves, the blocking device remains on board the truck. It can thereby affect the truck directly and it needs no external mechanical barrier to do so.

Moreover, the blocking device according to the invention is preferably provided with a receiving device that is adapted to receive the signal from the signaling device. Thus the receiving device serves to receive said signal. The receiving device is preferably located on the truck itself, particularly on the tractor of the truck and/or a trailer of the truck. The receiving device can thereby directly affect the truck.

It is particularly preferable that the receiving device is located in the transition area where the loading ramp is laid onto the truck. This arrangement makes it possible for a signal sent from the signaling device to be transmitted over a short, largely undisturbed signal path to the receiving device. It is also particularly advantageous for the signal according to the invention to have a comparatively short range, because then the signal has little potential for interference with other signal devices.

Advantageously, the blocking device is configured to lock the brakes of the truck. Brakes in trucks are, depending on the type of transmission of the braking power, usually compressed-air brakes or hydraulic brakes. Generally, the braking power works by means of a brake shoe on a disc or drum and prevents the wheels of the truck from turning. The wheels blocked in this way prevent movement of the truck. With the blocking device according to the invention a secure and, at the same time, damage-free as well as low-wear safety device by means of a simple and technically easily implemented operation of the brakes of the respective truck is created. However, movement of the truck can also be stopped by a reception unit electronically or mechanically preventing the truck from shifting into gear.

Additionally or alternatively, the blocking device according to the invention is configured to lock the truck's transmission. The power from the truck engine is transferred to the driving wheels through the transmission. The blocking of this transmission therefore prevents the force applied by the engine from being passed on to the wheels. Thus the movement of driving the truck away is adequately prevented. In particular, a movement of the truck can thus be prevented in accordance with the invention by blocking the shifting into gear of the transmission or by blocking engagement of the clutch.

In a preferred embodiment the blocking device is additionally or alternatively configured to block the truck starter. By means of the starter, the engine of the associated truck is started. The blocking according to the invention of this starter thus prevents a starting of the engine and so prevents a movement of the truck in a simple and, at the same time, secure way. Right at the start the driver is prevented from driving away from the loading ramp. Preferably the starting of the engine is inhibited by an interruption in the starter's electrical circuit.

Advantageously, according to the invention, the signaling device is equipped with a recognition unit by means of which the spatial position of the loading ramp is detected. The recognition unit recognizes its loading situation based on the spatial placement or position of the loading ramp. It is particularly checked if the loading ramp is folded upward, or if the loading ramp is folded downward, laying on the truck and thus making a connection to the truck. Preferably, the recognition unit for detection of the spatial position of the loading ramp is arranged on a device for moving this loading ramp, for example on a hydraulic cylinder.

Moreover, it is preferred to design the recognition unit with a sensor by means of which the spatial position of the loading ramp is detected. A sensor records the value of a variable to be measured in order to determine this variable to be measured. Here, the sensor detects which spatial position the loading ramp is in. Particularly suitable for this are sensors that recognize the position of the loading platform by waves of different frequencies. The sensor sends out waves and receives waves reflected back from an object, in particular from the loading ramp or the truck. Thus the distance to the object or the spatial position of the object can be determined. In particular, waves in the ultrasound, radio, or radar frequencies or light waves are sent. Particularly advantageous are ultrasound sensors, RFID sensors, radar sensors, or optical sensors like light barriers. These types of sensor are maintenance-free, contact-free, and insensitive to dirt. The position of the loading ramp is to be determined by means of these sensors for every loading situation.

Moreover, in an advantageous way the recognition unit is additionally or alternatively fitted with a pressure sensor by means of which the laying of the loading ramp on the truck is detected. The pressure sensor detects if a force is being applied to it. In particular, the force created by the weight of the loading ramp lying on the truck can be measured. Thus, in a simple way the information relevant here, namely whether the loading ramp is lying or not, is ascertained.

Alternatively or additionally the recognition unit may be provided with a proximity sensor by means of which the laying of the loading ramp onto the truck is detected. A proximity sensor detects if an object is approaching or is found within the detection range of the sensor, and produces a signal. Proximity sensors are primarily inductive sensors, capacitive sensors, and magnetic sensors. Preferably, the proximity sensor not only recognizes whether the loading ramp is lying on the truck, but also already activates the blocking device if the loading ramp approaches the truck. The proximity sensor detects the situation of the loading ramp touch-free and thus particularly low-maintenance.

Especially preferred is the signaling device provided with a transmitter by means of which the signal regarding the situation at the loading ramp is transmitted to the signaling device on the truck. The transmitter transmits a signal from the transmitter to the receiving device. The transmission is realized by means of radio in particular. Therefore a cable is not necessary for the signal transmission. Particularly advantageous is to transmit the signal from the rear loading or unloading area of the truck to the driver's area of the truck.

### BRIEF DESCRIPTION OF THE DRAWINGS

In the following an exemplary embodiment of the solution according to the invention is explained in more detail on the basis of the attached schematic drawings, which show:

FIG. 1 is a side view of an exemplary embodiment of a loading-ramp safety device according to the invention with associated loading ramp and a truck docked onto it.

FIG. 2 is a side view of the loading ramp according to FIG. 1 in an operational state.

FIG. 3 is a side view of the loading ramp according to FIG. 1 in a standby state.

FIG. 4 is a side view of a further example for the execution of a loading-ramp safety device according to the invention with associated loading ramp.

FIG. 5 is a side view of a loading-ramp safety device according to the invention with a truck with a trailer docked onto it.

### DETAILED DESCRIPTION

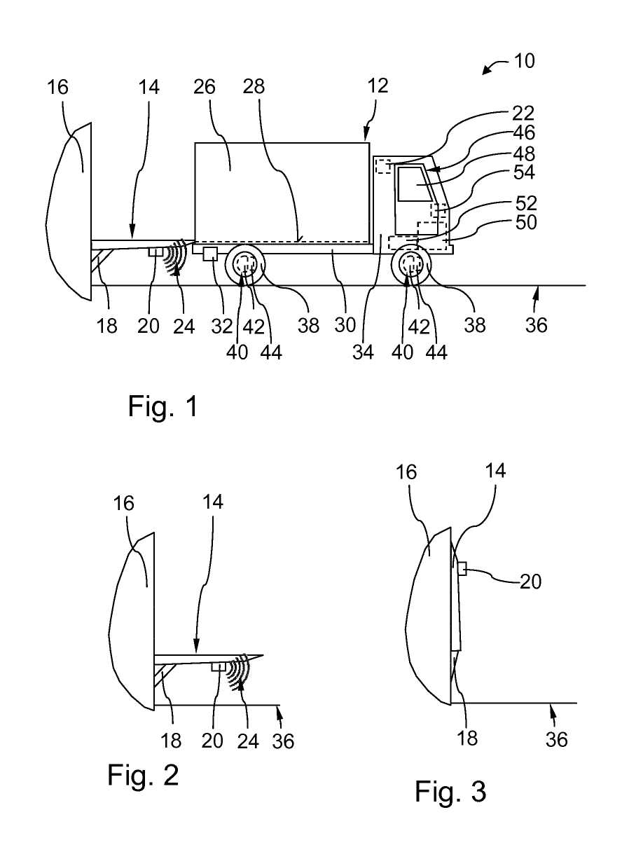

FIG. 1 shows a loading-ramp safety device 10 with a truck 12, that is by means of a loading ramp 14 connected to a storage facility 16. The loading ramp 14 of this design is also called a dock leveler.

Provided at the loading ramp 14 are a lifting cylinder 18 and a signaling device 20 that is connected with a blocking device 22 in the truck 12 by means of a signal 24.

The truck 12 has a cargo space 26 with a cargo area 28 that are provided on the frame 30 of the truck 12. On the frame 30 a receiving device 32 is attached. The receiving device 32 can alternatively also be arranged in or at the driver's cab 34 of the truck 12.

On the frame 30 are also located the wheels 38 directed to the driving surface 36. The wheels 38 are located to the rear of the truck 12 under its cargo space 26 and to the front under its driver's cab 34. Each of these wheels 38 has a brake 40 which contain a brake disc 42 and a brake caliper 44.

For entry into the driver's cab 34 a door 46 with a window 48 is provided. Under the driver's cab 34 an engine 50 is provided having a power-transfer transmission 52 connected to it. This engine 50 can be started by means of a starter 54.

With the lifting cylinder 18 the loading ramp 14 can be swung around an axle not shown here. By pivoting downward in the direction of the driving surface 36 the loading ramp 14 thus establishes a coupling or connection to the cargo area 28 of the truck 12. Then a load (not shown) is loaded or unloaded over the loading ramp 14 between the cargo area 28 and the storage facility 16.

The signaling device 20 transmits by means of the signal 24 to the receiving device 32, whether the loading ramp 14 lies on, or is coupled or connected to the truck, or not. If the loading ramp 14 lies on, or is coupled or connected, the blocking device 22 prevents the truck 12 from being moved away from the loading ramp 14 by a blocking of the brake 40, a blocking of the starter 54, and/or a blocking of the transmission 52.

FIG. 2 shows the loading ramp 14 of the storage facility 16, which by means of the lifting cylinder 18 is folded down around the axle parallel to the driving surface 36. On this loading platform 14 is located on its underside the signaling device 20 that send out the signal 24. Since the loading ramp 14 is parallel to the driving surface 36, the signal 24 is also sent parallel to the driving surface 26 in the direction of the truck 12. The loading ramp 14 in an advantageous way screens this signal transmission upward.

FIG. 3 also shows the loading ramp 14 on the storage facility 16. This loading ramp 14 is folded upward by means of the lifting cylinder 18. The signaling device 20 located on the loading ramp 14 is thus also folded upward with the loading ramp 14. Since this loading platform 14 is in the folded standby condition, this condition is accordingly recognized and no signal 24 is sent from this signaling device 20. Alternatively, a signaling device 20 can then also send a signal 24 up, which accordingly, however, cannot be received by a truck 12.

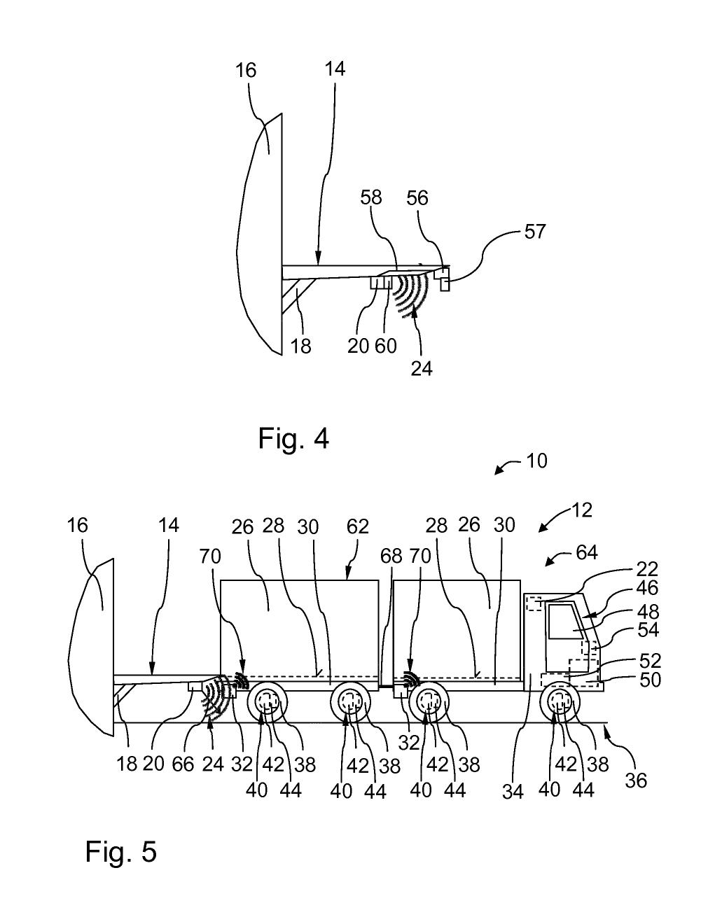

FIG. 4 shows another loading ramp 14 with the associated lifting cylinder 18 on the storage facility 16. On the underside of the end of this loading ramp 14 opposite the storage facility 16 is mounted a recognition unit 56 with a sensor 57 that is connected to the signaling device 20 by means of a signal line 58. This signaling device 20 transmits the signal 24 by means of a transmitter 60. The sensor 57 serves to recognize whether the loading ramp 14 lies on a truck 12 or not.

FIG. 5 illustrates an alternative embodiment of the loading-ramp safety device 10 with a truck 12 consisting of a tractor 64 and a trailer 62. The trailer 62 encompasses the cargo space 26 on the associated frame 30 with the receiving device 32 there and a coupler 68. On the frame 30 is the receiving device 32 on the back end, away from the tractor 64.

The trailer 62 is likewise fitted with wheels 38 with brakes 40. The trailer 62 establishes by means of a coupler 68 a connection between the trailer 62 and the tractor 64. The tractor 64 is designed with cargo space 26 and driver's cab 34 similar to the truck in accordance with FIG. 1. The blocking device 22 for the starter 54 and/or the transmission 52 is located at the driver's cab 34.

The cargo space 26 of the trailer 62 is connected to the storage facility 16 by the loading ramp 14. The lifting device 18 is located on the side of loading ramp 14 facing the storage facility 16 and the signaling device 20 at the end of the loading ramp 16 facing the trailer 62. This signaling device 20 transmits a signal 24 with a short range 66 that will be received by the receiving device 32 on the back end of the frame 30 of the trailer 62. The receiving device 32 and the transmitter 20 are thus coupled to each other by means of the signal 24.

The signal 24 is transmitted from the receiving device 32 of the trailer 62 by means of another signal 70 to the receiving device 32 of the tractor 64 and further to the blocking device 22 on the tractor 64. Then, with the applied signal 70, the blocking device 22 blocks the truck 12 so that a driving off or rolling away is prevented. In particular, the brake 40 is blocked to prevent the rolling away and/or driving off is prevented by blocking the starter 54.

For a storage facility 16 that has a large storage area in which numerous deposit and removal movements take place, several loading ramps 14 are arranged side-by-side. As a result, several loading-ramp safety devices 10 arranged side-by-side are also necessary. Due to the comparatively short range 66 of the signal 24, an overlapping of the signals 24 from multiple signaling devices is avoided as far as possible. An unambiguous allocation of the respective loading ramp 14 to the respective truck 12 is thus easier to realize.

### LIST OF REFERENCE TERMS

10 Loading-ramp safety device
12 Truck
14 Loading ramp
16 Storage facility
18 Lifting cylinder
20 Signaling device
22 Blocking device
24 Signal
26 Cargo space
28 Cargo area
30 Frame
32 Receiving device
34 Driver's cab
36 Driving surface
38 Rad
40 Brake
42 Brake shoe
44 Brake caliper
46 Door
48 Window
50 Engine
52 Transmission
54 Starter
56 Recognition unit
57 Sensor
58 Signal line
60 Transmitter
62 Trailer
64 Tractor
66 Range
68 Coupler
70 Signal

1.-10. (canceled)

11. A loading-ramp safety device for a loading ramp to be laid on a truck with
a signaling device associated with the loading ramp and
a blocking device associated with the truck,
wherein the signaling device is configured to transmit a signal regarding a loading situation at the loading ramp, and
wherein the blocking device is located on board the truck and is configured
to receive the signal, and, in accordance with the signal,
to prevent the truck from moving away from the loading ramp.

12. The loading-ramp safety device as in claim 11,
wherein the blocking device is provided with a receiving device that is adapted to receive the signal from the signaling device and is located on the truck.

13. The loading-ramp safety device as in claim 11,
wherein the blocking device is configured to block a brake of the truck.

14. The loading-ramp safety device as in claim 11,
wherein the blocking device is configured to block a transmission of the truck.

15. The loading-ramp safety device as in claim 11,
wherein the blocking device is configured to block a starter of the truck.

16. The loading-ramp safety device as in claim 11,
wherein the signaling device is equipped with a recognition unit by means of which a spatial position of the loading ramp is detected.

17. The loading-ramp safety device as in claim 16,
wherein the recognition unit is fitted with a sensor by means of which a spatial position of the loading ramp is detected.

18. The loading-ramp safety device as in claim 16,
wherein the recognition unit is fitted with a pressure sensor by means of which a lying of the loading ramp on the truck is detected.

19. The loading-ramp safety device as in claim 16,
wherein the recognition unit is fitted with a proximity sensor by means of which a lying of the loading ramp on the truck is detected.

20. The loading-ramp safety device as in claim 11,
wherein the signaling device is equipped with a transmitter by means of which the signal regarding the loading situation at the loading ramp from the signaling device is transmitted to the truck.
